(19) United States
(12) Patent Application Publication
(10) Pub. No.: US 2013/0132175 A1
(43) Pub. Date: May 23, 2013

(54) MOBILE DEVICE REBATE SYSTEM

(71) Applicant: Maritz Holdings Inc., Fenton, MO (US)

(72) Inventors: Sean Claessen, Toronto (CA); Jonathan Gingerich, Toronto (CA); Sean Dempsey, Toronto (CA)

(73) Assignee: MARITZ HOLDINGS INC., Fenton, MO (US)

(21) Appl. No.: 13/683,671

(22) Filed: Nov. 21, 2012

Related U.S. Application Data
(60) Provisional application No. 61/563,235, filed on Nov. 23, 2011.

(51) Int. Cl. G06Q 30/02

(52) U.S. Cl. CPC G06Q 30/0215
USPC 705/14.17; 705/14.1

(57) ABSTRACT

A mobile rebate application (mobile rebate APP) to obtain a rebate related to a mobile device or service of the mobile device. The APP submits a rebate request form to a rebate control center which validates, approves and authorizes rebates. The rebate may be applied to the carrier billing system of the mobile device via a mobile application storefront and/or via a social gifting platform.

### BACKGROUND OF THE INVENTION

The present invention generally relates to a system for use with mobile devices allowing participation in a rebate program. For example, the program may be a mobile device trade-in program, a mobile device trade-up program or other rebate program, in which a rebate or other currency (e.g., points) is awarded to a customer having the mobile device.

Prior trade-in, trade-up or other rebate program systems are manual in nature, have a lengthy validation/approval/authorization process, requiring multiple point-of-sale systems, integrations and/or the award is provided/fulfilled in the form of a physical paper check, a bank draft, an electronic funds transfer, or a pre-denominated or re-loadable gift card.

### BRIEF DESCRIPTION OF THE DRAWINGS

FIG. 1 is a flow diagram showing various interactions according to one embodiment of the system 100 of the invention.

FIG. 2 is a block diagram of one embodiment of the system 100 of the invention showing various detailed interactions at a specific level.

FIG. 3 is a block diagram illustrating the process of operation of one embodiment of the system 100 of the invention showing various interactions at a less specific level than FIG. 2.

FIG. 4 is a flow chart of one embodiment of the mobile rebate APP of the invention.

FIGS. 5A-5E are an example of screen shots of a graphical user interface presented to a customer when a mobile rebate APP is activated by the customer.

### SUMMARY

In one form, the invention comprises a system for use by customers each having a mobile device which has a mobile rebate application (mobile rebate APP) thereon. The system comprises a rebate control center accessible by a mobile rebate APP of the mobile devices for providing a rebate amount to the customer having the mobile device. The rebate control center receives a rebate request from the mobile rebate APP of the mobile devices, selectively validates the received requests, selectively approves the validated requests, and selectively authorizes a rebate amount to be applied to an account of the customer having the mobile device. The rebate amount is related to the mobile device or a service of the mobile device.

In another form, the invention comprises a method for use by customers each having a mobile device which has a mobile rebate application (mobile rebate APP) thereon. The method comprises:
receiving a rebate request from a mobile rebate APP,
selectively validating the received requests,
selectively approving the validated requests, and
selectively authorizing a rebate amount to be applied to an account of the customer having the mobile device.

In another form, the invention comprises a mobile rebate application (mobile rebate APP) comprising computer executable instructions stored in a fixed tangible medium and configured to be executed by a processor of a mobile device of a customer. The mobile rebate APP is for use with a rebate control center for providing a rebate request for the mobile device. The mobile rebate APP comprises instructions for:
accessing the mobile device to determine identification information for uniquely identifying the mobile device;
generating a rebate request form;
populating the rebate request form with the determined identification information; and
providing the populated rebate request form to the rebate control center.

In another form, the invention comprises a system as noted above and mobile rebate application (mobile rebate APP) as noted above.

### DETAILED DESCRIPTION

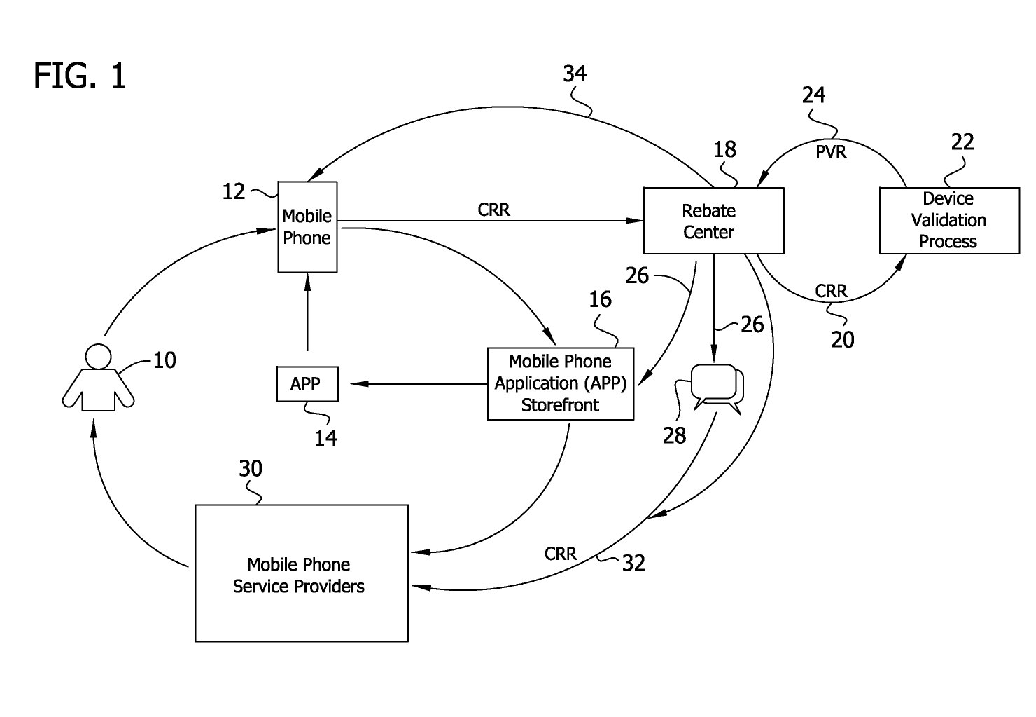

Referring to FIG. 1, the rebate system provides a framework through which rebate, trade-up or trade-in programs (herein rebate programs) for mobile devices can be implemented in a more efficient manner than is currently implemented. FIG. 1 illustrates an example of a system in which the mobile device qualifying for a rebate is a mobile phone (e.g., a cell phone, a smart phone or cellular handheld device) or a service related to the mobile phone (e.g., upgraded or expanded service). Specifically, a customer 10 may purchase, lease, upgrade, trade-up, trade-in or otherwise commit to a product or service which qualifies for a rebate and which product or service is connected to a mobile phone 12. As used herein, a mobile device may include but is not limited to the following: handheld devices, MDAs, PDAs, pagers, digital cameras, pocket PCs, digital audio players, cell phones, smart phones, laptops, tablets, GPSs and, in general, and/or any device which includes a processor for executing a device rebate application (rebate APP) and which device has access to a communication network such as WiFi, 3G, 4G, cellular or other global networks. For example, it is contemplated that the invention may be used with a desktop computer which qualifies for a rebate. For convenience, the following assumes that customer 10 has purchased mobile phone 12 or a mobile phone service, which purchase qualifies the customer to a rebate amount.

According to aspects of the invention, the customer 10 will use a mobile rebate application 14 (herein mobile rebate APP 14) on their mobile phone 12 to submit a rebate request via WiFi or a cellular network. The mobile rebate APP 14 may be pre-installed on the mobile phone 12 or the customer 10 may obtain the APP 12 from a mobile phone application (APP) server 16, e.g., an APP store front. If the customer 10 does not have a mobile rebate APP 14 on their phone 10, they would go to their mobile storefront 16 to download the mobile rebate APP 14.

Upon activating the APP 14, instructions within the APP 14 collect information regarding the mobile phone and the reason for the rebate. For example, the instructions of the APP 14 may automatically search components of the mobile phone to determine identification information which uniquely identifies each mobile phone (e.g., internal serial number). Alternatively or in addition, the instructions of the APP 14 may automatically search components of the mobile phone, such as the customer information, to determine identification information which uniquely identifies each customer. Alternatively or in addition, the instructions of the APP 14 may request input from the customer to identify the mobile phone or the customer or the transaction involved which qualifies for the rebate.

After the identification information is collected, it is populated into a completed rebate request (CRR) which is transmitted (either manually or automatically via WiFi or a cellular network) to a Rebate Control Center and Engine 18. The Rebate Control Center 18 responds to the received CRR to validate the rebate request. In one form the center 18 sends relevant product, transaction and/or customer information 20 to a validation system 22 of the manufacturer/supplier/provider of the mobile phone 12. In response, the validation system 22 sends a “product/service validity” response (PVR) 24 with information regarding products/services which qualify for a rebate.

The Rebate Center 18 determines the eligibility of the purchased product/service for a rebate, by comparing the product/service information in the rebate request to the product/service information in the product validity response. The Rebate Center 18 approves eligible rebate requests at 26 and authorizes a rebate amount to be provided to the customer via the storefront 16 which may be associated with a service provider 30 of the mobile device, via a gifting platform 28 associated with a service provider 30 of the mobile phone 12 and/or via the service provider 30.

In one embodiment, the product information in the rebate request is evaluated by rules in the rebate engine according to data (e.g., serial number, activation date, service level, confirmation of valid product, etc.) specified by the product validity response (PVR) 24. Rebate requests which pass the criteria for the program are then eligible for the calculated rebate amount. This rebate amount may be credited to the customer's monthly wireless mobile account through carrier billing integration (CBR) 32, such as integration through the mobile application storefront. Optionally, communications 34 may be sent to the customer 10 from the Rebate Control Center 18, notifying the customer 10 of the status of the rebate and other relevant information. As a result, the rebate is provided to the customer 10 with minimal customer involvement.

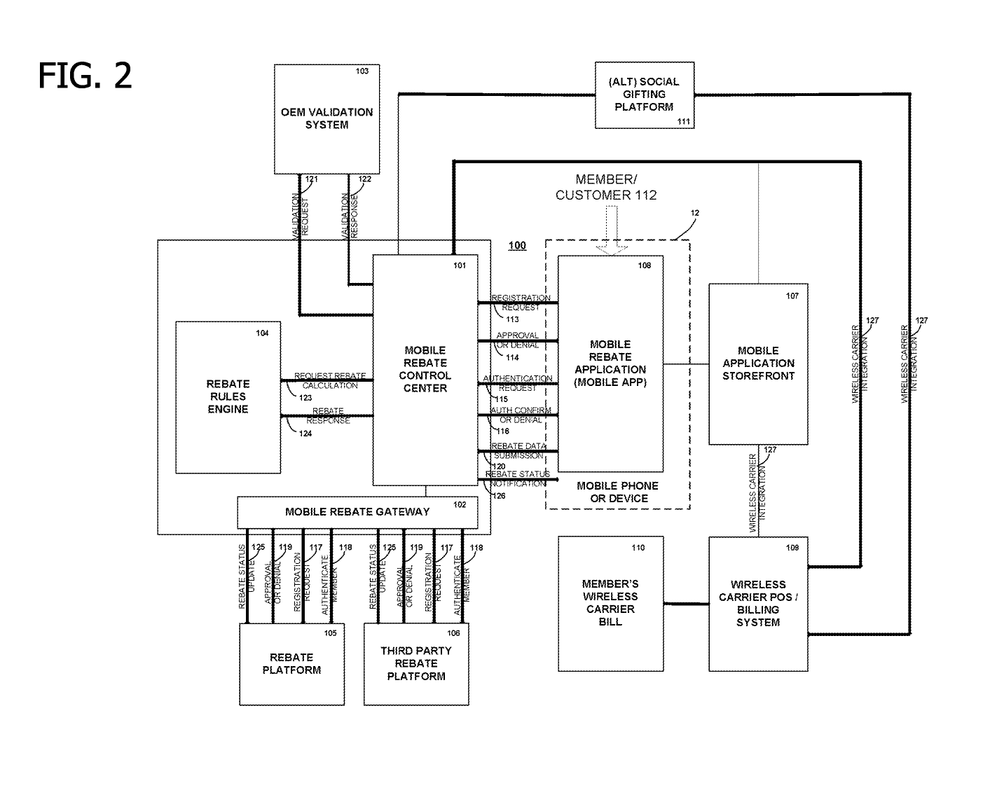

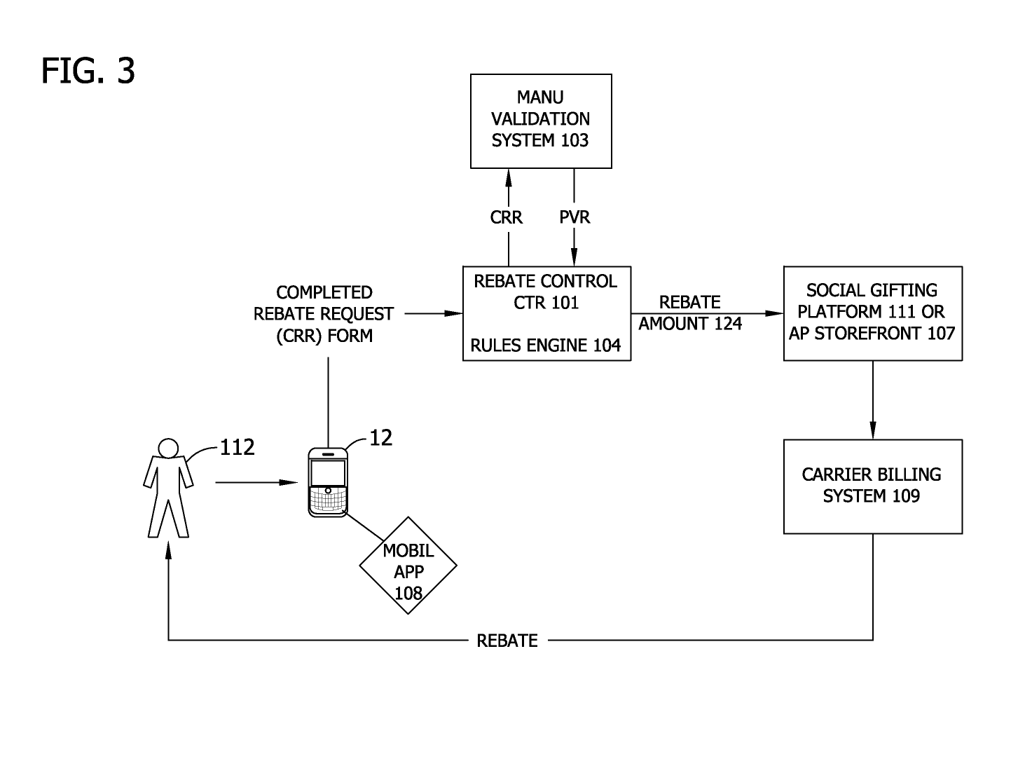

Referring to FIGS. 2 and 3, a mobile rebate system 100 allows members/customers 112 of programs such as a trade-in, trade-up or rebate program 105 or 106, to use a mobile rebate application 108 (mobile rebate APP 108) to submit their claim activity based on the rules and structure of the program. The profile data and claim activity are stored in a database 105 or 106 (which may be managed by a 3^{rd} party) and may utilize existing wireless carrier integrations 127 with the mobile application storefront 107 to complete the financial rebate transaction. The rebate transaction is, from the perspective of the wireless carrier POS/billing system 109, a conventional purchase transaction charged to the wireless customer's monthly bill 110. Because of this, no custom integration or modification is required to the participating carrier's point-of-sale or billing systems 109.

### DETAILED OPERATION

The program member/customer 112 executes the mobile rebate application (mobile rebate APP) 108 of their mobile phone 12 which allows the member to apply rebate amounts to their monthly wireless carrier bill 110 of their carrier 109. The customer 112 may be required to log-in to the mobile rebate APP 108 which sends a registration request 113 to a mobile rebate control center 101.

The mobile rebate control center 101 connects to the rebate program platform 105 (operates the program) or 106 (3^{rd} party operates the program) through the mobile rebate gateway 102 to submit the registration request 117. Upon successful registration (or if registration is not needed), the mobile APP 108 and control center 101 exchange information at 115, 116 to authenticate the customer 112.

Upon successful authentication, the mobile rebate APP 108 collects relevant information about the mobile phone 12 (i.e., information regarding the device it is installed on) and transmits it to the mobile rebate control center 101 for processing. For example, the customer 112 may be provided with a rebate request (RR) graphical user interface which must be completed by the customer 112, and the completed rebate request (CRR) is provided to the rebate control center 101. In one embodiment, data collection involves the customer 112 who accesses a “Rebate Submission” page within the mobile rebate APP 108 and enters the information required to process the rebate request (RR).

In one embodiment, the mobile rebate control center 101 submits a completed rebate request (CRR) 121 containing the applicable collected information regarding the purchased product to the manufacturer's OEM validation system 103 for processing. For example, if the rebate qualifies from a purchased software product or a purchases service, the mobile rebate control center 101 submits a validation request 121 containing the applicable collected information to the software or service provider for processing.

The OEM validation system 103 validates the information sent and provides a validation response 122 containing applicable validation information back to the mobile rebate control center 101.

The mobile rebate control center 101 sends the product validity response (PVR) data received from the OEM validation system 103 to a rebate rules engine 104 to determine eligibility of the claim and to calculate the eligible rebate amount. The rebate rules engine 104 calculates the eligible rebate from the data provided by the OEM validation system 103 and sends an approved rebate response 124 to the mobile rebate control center 101.

The mobile rebate control center 101 will authorize and credit the member's wireless carrier bill 110 with the calculated rebate amount 124 by connecting to and interfacing with the wireless carrier POS/billing system 109, such as through wireless carrier billing integration 127 via the mobile application storefront 107.

Alternatively or in addition, the mobile rebate control center 101 will send the authorized rebate amount 124 to the intended customer 112 through a Social Gifting Platform 111 (e.g., BlackBerry Messenger (BBM)™, Facebook®, Groupon®), which in turn, credits the member's wireless carrier bill 110 with the calculated rebate amount 124 by connecting to the wireless carrier POS/billing system 109 through the wireless carrier integration 127 or via the mobile application storefront 107.

The mobile rebate control center 101 triggers a rebate status notification 126 to the mobile rebate APP 108 (or via email), informing the customer that the rebate is being processed, has been processed and/or has been awarded and credited to the customer's account.

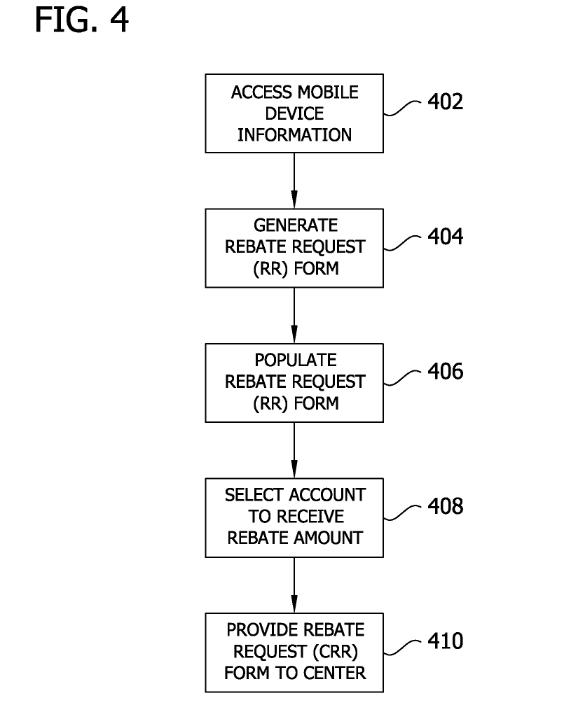

Thus, in one embodiment, the invention comprises a mobile application (e.g., mobile rebate APP 14, 108) as illustrated in FIG. 4 for interfacing with the rebate control center 18, 101 for providing the rebate request RR for the mobile phone 12 or related service which may qualify for a rebate. The mobile rebate APP 14, 108 also interfaces with the rebate control center 101 which receives and processes the completed rebate request CRR from the mobile rebate APP. The rebate control center 101 and engine 104 validates and approves the received request and authorizes a rebate amount to be applied to an account related to the mobile device. In this embodiment, the mobile rebate APP comprises computer executable instructions stored on a fixed tangible media (e.g., a memory of the mobile device). The instructions are executed by a processor of the mobile device. The instructions comprise:
instructions 402 for accessing the mobile device to determine identification information for uniquely identifying the mobile device;
instructions 404 for generating a rebate request form;
instructions 406 for populating the rebate request form with the determined identification information; and
instructions 410 for providing the populated rebate request form to the rebate control center.

Optionally, the instructions may also include instructions 408 for presenting to the customer a user interface requesting the customer identify an account to which the rebate amount should be applied.

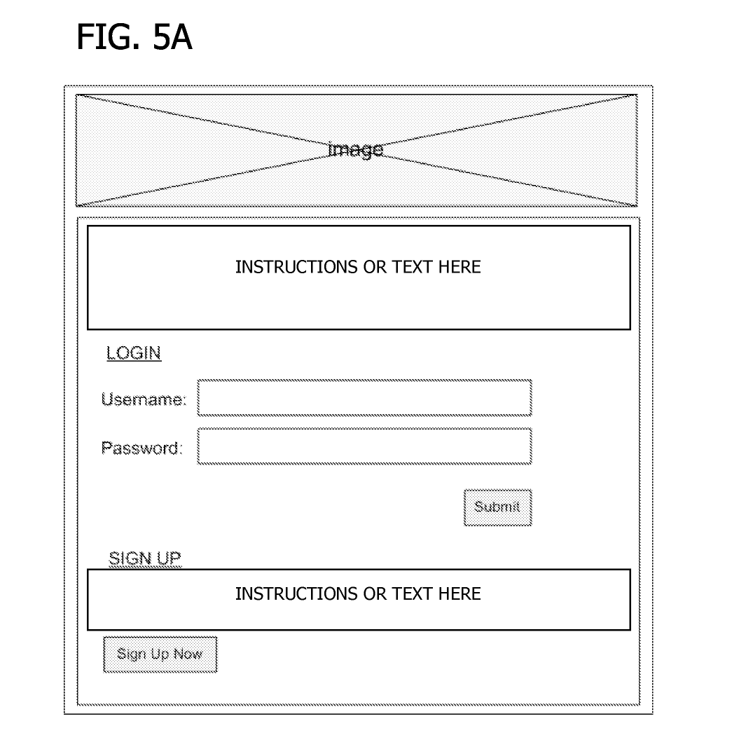

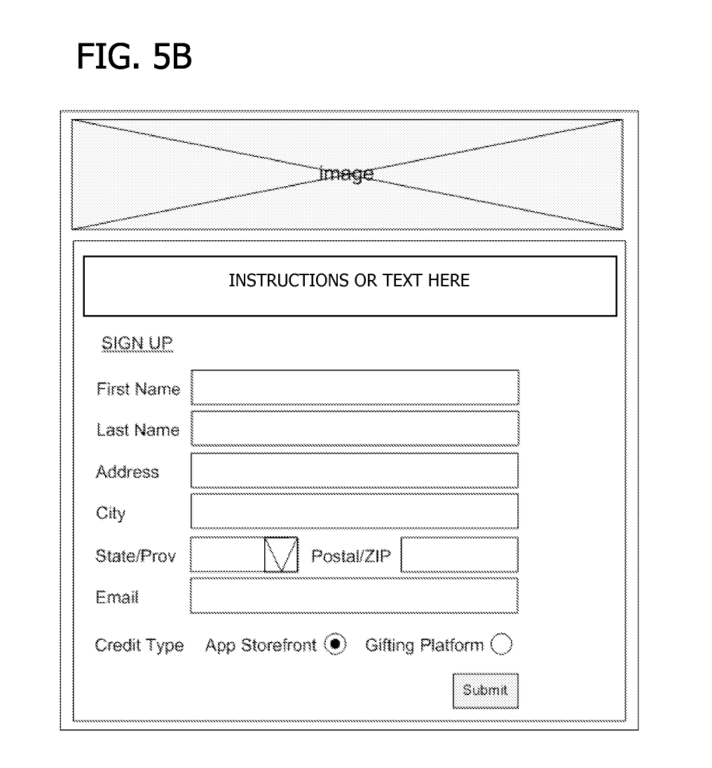

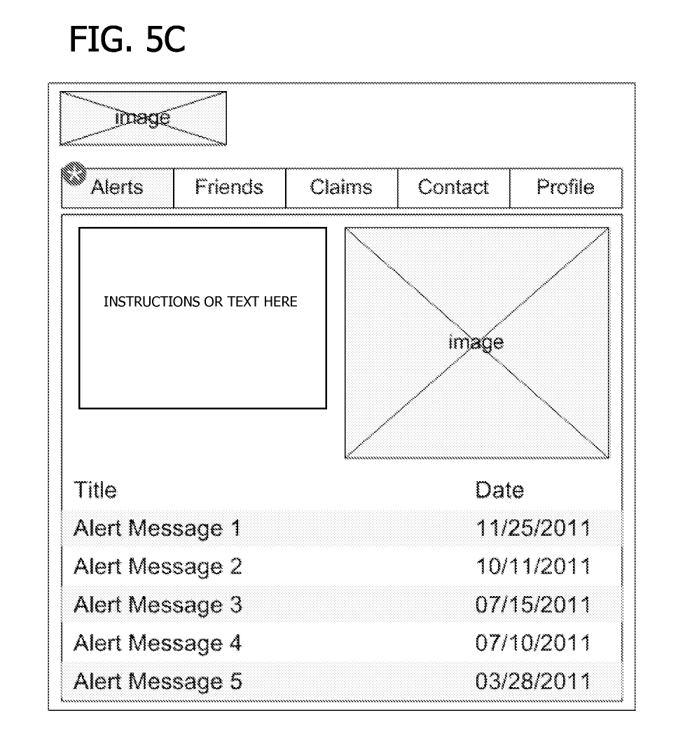

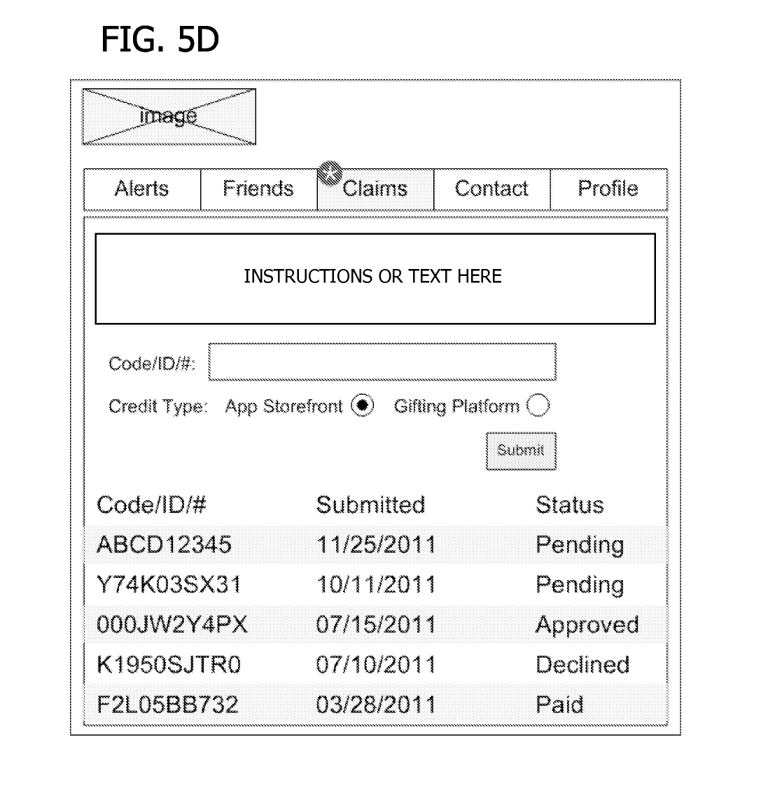

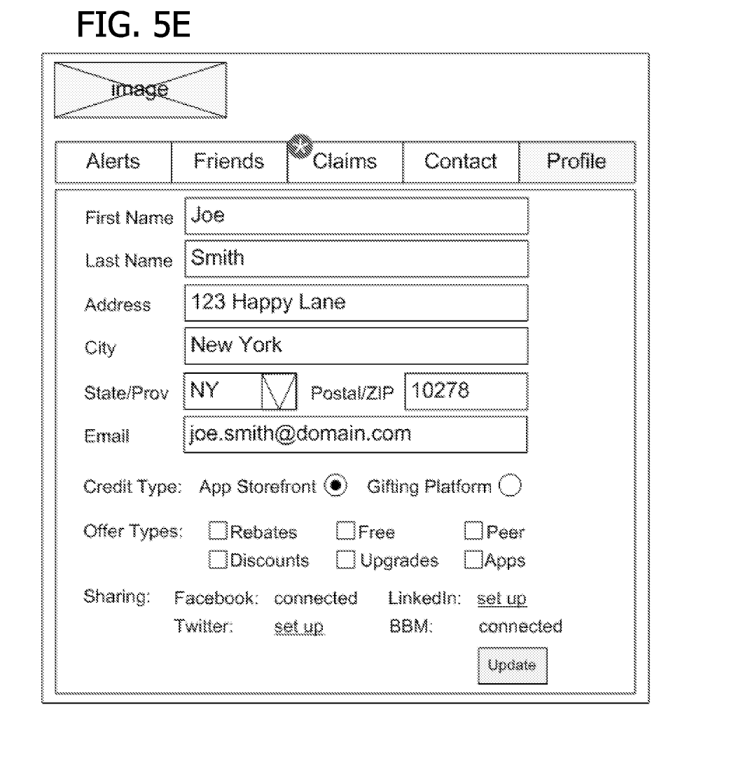

FIGS. 5A-5E are an example of screen shots of a graphical user interface presented to a customer when a mobile rebate APP is activated by the customer. FIG. 5A illustrates a screen shot of a graphical user interface presented to a customer in order to direct the customer to “log in” for customers who have previously signed up. FIG. 5B illustrates a screen shot of a graphical user interface presented to a customer in order to direct the customer to “sign up.” FIG. 5C illustrates a screen shot of an “Alerts” tab of a graphical user interface presented to a customer in order to present “alerts” or messages to the customer. FIG. 5D illustrates a screen shot of a “Claims” tab of a graphical user interface presented to a customer in order to present the status of various claims submitted by the customer. FIG. 5E illustrates a screen shot of a “Profile” tab of a graphical user interface presented to a customer in order to permit the customer to input or update their personal and contact information. FIGS. 5D and 5E also include an input to permit the customer to select “credit type” so that the rebate is applied to the customer's “App Storefront” account or applied via a “Gifting Platform.” Each screen shot may include one or more images and additional instructions or text.

According to one embodiment of the invention, the blocks of FIGS. 1-3 (other than the mobile device) may be implemented by a server or processor executing computer executable instructions stored in fixed, tangle medium in accordance with the functions and operations described herein. Alternatively or in addition, some or all of the blocks may be combined and implemented by a single server/processor executing instructions.

For example, the rebate control center 101 may comprise a server or processor executing computer executable instructions stored in a tangible medium, including instructions for providing a rebate request and instructions for authorizing a rebate amount to a carrier billing system 109 via a carrier billing integration link.

As another example, the rebate control center 101 and engine 104 may comprise a server or processor executing computer executable instructions stored in a tangible medium, including instructions for receiving a completed rebate request, instructions for validating the completed request, instructions for approving the validated request and instructions for authorizing a rebate amount 124 for an approved request. The validating instructions may include instructions for interfacing with a manufacturer validation system 103. The instructions for providing a rebate amount may include instructions for interfacing with a social gifting platform for providing the rebate amount via the social gifting platform to the carrier billing system. The instructions for providing a rebate amount may also include instructions for interfacing with the mobile application storefront 107 for providing the rebate amount via the storefront to the carrier billing system 109.

In one form, the invention comprises a method for use by customers each having a mobile device which has a mobile rebate application (mobile rebate APP) thereon, said method comprising:
receiving completed rebate requests from each mobile rebate APP,
selectively validating the received requests,
selectively approving the validated requests, and
selectively authorizing a rebate amount to be applied to an account of the customer having the mobile device.

The above summary is provided to introduce a selection of concepts in simplified form that are further described below in the Detailed Description. The summary is not intended to identify key features or essential features of the claimed subject matter, nor is it intended to be used as an aid in determining the scope of the claimed subject matter.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of data and/or computer-executable instructions, such as program modules, stored one or more tangible computer storage media and executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, computers and/or servers may execute the computer-executable instructions such as those illustrated herein to implement aspects of the invention.

Embodiments of the invention may be implemented with computer-executable instructions. The computer-executable instructions may be organized into one or more computer-executable components or modules on a tangible computer readable storage medium. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

The Abstract and summary are provided to help the reader quickly ascertain the nature of the technical disclosure. They are submitted with the understanding that they will not be used to interpret or limit the scope or meaning of the claims.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A system for use by customers each having a mobile device which has a mobile rebate application (mobile rebate APP) thereon, said system comprising:
a rebate control center accessible by a mobile rebate APP of the mobile devices for providing a rebate amount to the customer having the mobile device; and
said rebate control center for receiving a rebate request from the mobile rebate APP of the mobile devices, for selectively validating the received requests, for selectively approving the validated requests, and for selectively authorizing a rebate amount to be applied to an account of the customer having the mobile device wherein the rebate amount is related to the mobile device or a service of the mobile device.

2. The system of claim 1 wherein the completed rebate request received by the rebate control center includes identification information generated by the mobile rebate APP and uniquely identifying its mobile device.

3. The system of claim 2 wherein the rebate control center applies the rebate amount to an account associated with the mobile device of the customer by interfacing with a carrier billing system of the mobile device.

4. The system of claim 2:
wherein the rebate control center applies the rebate amount to an account of the customer associated with the mobile device by interfacing with a carrier billing system of the mobile device and wherein the rebate control center interfaces with the carrier billing system of the mobile device via a mobile application storefront; and/or
wherein the rebate control center applies the rebate amount via a social gifting platform.

5. The system of claim 2 further comprising a rebate rules engine wherein the rebate control center interfaces with the rebate control engine to approve validated requests.

6. The system of the claim 2 wherein the rebate control center interfaces with a validation system for validating the received request.

7. The system of claim 2 wherein the rebate control center interfaces with a validation system of a manufacturer of the mobile device for validating the received request and/or interfaces with a validation system of a supplier of the mobile device for validating the received request.

8. A system for use with a mobile device of a customer, said system comprising:
a mobile rebate APP on the mobile device;
a rebate control center accessible by a mobile rebate APP of the mobile devices for providing a rebate amount to the customer having the mobile device; and
said rebate control center for receiving a rebate request from the mobile rebate APP of the mobile devices, for selectively validating the received requests, for selectively approving the validated requests and for selectively authorizing a rebate amount to be applied to an account of the customer having the mobile device;
wherein the mobile rebate APP comprises computer executable instructions stored in a fixed tangible medium of the mobile device and configured to be executed by a processor of the mobile device, said mobile rebate APP for use with the rebate control center for providing a rebate request for the mobile device, said mobile rebate APP comprising instructions for:
accessing the mobile device to determine identification information for uniquely identifying the mobile device;
generating a rebate request form;
populating the rebate request form with the determined identification information; and
providing the populated rebate request form to the rebate control center.

9. The system of claim 8 wherein the completed rebate request received by the rebate control center includes identification information generated by the mobile rebate APP and uniquely identifying its mobile device.

10. The system of claim 9 wherein the rebate control center applies the rebate amount to an account associated with the mobile device of the customer by interfacing with a carrier billing system of the mobile device.

11. The system of claim 9:
wherein the rebate control center applies the rebate amount to an account of the customer associated with the mobile device by interfacing with a carrier billing system of the mobile device and wherein the rebate control center interfaces with the carrier billing system of the mobile device via a mobile application storefront; and/or
wherein the rebate control center applies the rebate amount via a social gifting platform.

12. The system of claim 9 further comprising a rebate rules engine wherein the rebate control center interfaces with the rebate control engine to approve validated requests.

13. The system of the claim 9 wherein the rebate control center interfaces with a validation system for validating the received request.

14. The system of claim 9 wherein the rebate control center interfaces with a validation system of a manufacturer of the mobile device for validating the received request and/or interfaces with a validation system of a supplier of the mobile device for validating the received request.

15. The system of claim 9 wherein the mobile rebate application further comprising instructions for presenting to the customer a user interface requesting the customer identify an account to which the rebate amount should be applied.

16. A method for use by customers each having a mobile device which has a mobile rebate application (mobile rebate APP) thereon, said method comprising:
receiving a rebate request from a mobile rebate APP,
selectively validating the received requests,
selectively approving the validated requests, and
selectively authorizing a rebate amount to be applied to an account of the customer having the mobile device.

17. The method of claim 16 wherein the completed rebate request includes identification information generated by the mobile rebate APP and uniquely identifying each mobile device.

18. The method of claim 17 further comprising applying the rebate amount to an account associated with the mobile device by interfacing with a carrier billing system of the mobile device.

19. The method of claim 17 further comprising:
applying the rebate amount to an account associated with the mobile device by interfacing with a carrier billing system of the mobile device and interfacing with the carrier billing system of the mobile device via a mobile application storefront; and/or
applying the rebate amount via a social gifting platform.

20. The method of claim 17 further comprising interfacing with a rebate control engine to approve validated requests.

21. The method of the claim 17 further comprising interfacing with a validation system for validating the received request.

22. The method of claim 17 further comprising interfacing with a validation system of a manufacturer of the mobile device for validating the received request and/or interfacing with a validation system of a supplier of the mobile device for validating the received request.

23. A mobile rebate application (mobile rebate APP) comprising computer executable instructions stored in a fixed tangible medium and configured to be executed by a processor of a mobile device of a customer, said mobile rebate APP for use with a rebate control center for providing a rebate request for the mobile device, said mobile rebate APP comprising instructions for:
accessing the mobile device to determine identification information for uniquely identifying the mobile device;
generating a rebate request form;
populating the rebate request form with the determined identification information; and
providing the populated rebate request form to the rebate control center.

24. The mobile rebate application of claim 20 further comprising instructions for presenting to the customer of the mobile device a user interface requesting the customer identify an account to which the rebate amount should be applied.
